(19) United States
(12) Patent Application Publication
(10) Pub. No.: US 2012/0296787 A1
(43) Pub. Date: Nov. 22, 2012

(54) Personal Transaction Number

(75) Inventor: Bill J. Goss, Patterson, CA (US)

(73) Assignee: Bill J. Goss, Patterson, CA (US)

(21) Appl. No.: 13/440,964

(22) Filed: May 16, 2012

Related U.S. Application Data
(60) Provisional application No. 61/519,203, filed on May 18, 2011.

(51) Int. Cl. G06Q 40/00

(52) U.S. Cl. 705/35

(57) ABSTRACT

The Personal Transaction Number, (PTN), will cease fraudulent Activity in the banking industry and even some secured web sites. It is a series of numbers which shall be offered by banking, credit and Insurance industries, to their customers. A series of (PTN) in check size booklets, with each individual page displaying indentifying numbers in sequence, shall be offered to each customer. Whenever a customer is using the credit honor system at any Point of Sale, (POS), or to even access secured web sites, such as being offered by insurance companies, the customer will now have to offer a new (PTN) in sequence from this (PTN) booklet, which the customer shall have to carry on their person. This procedure shall be put into place so as to have their credit, or acceptance of entry into a web site, go forward.

Since credit has been extended to the consumer, either by credit cards, debit cards And bank checking, there have been fraudulent acts to separate the consumer from Their finances. Even in the auto and home insurance levels, when a customer has to Get onto their insurance carriers web site, often times there has to be a level of protection for the customer, ie: a continuing change of password.

The Personal Transaction Number, (PTN), shall control these fraudulent acts by something As simple as having the banking credit and insurance industries, issue a series of (PTN) In check size books, with a series of identifying numbers on each page to their customers. Each customer will now have to offer a new (PTN) in sequence from this (PTN) book which they shall have to carry on their person, whenever they are using the credit honor system at any Point of Sale, (POS). Even to access secured web sites such as insurance companies, which shall allow the transaction, or connection to go forward.

Banks who will offer the (PTN) shall have to provide a designated place on the customers Checks for the (PTN) sequence number, to be entered by the customer, as well as the check Sequence number provided by the bank.

The programs for the credit card machines which are now being used at all (POS) shall have To be modified by the, (PTN) Utility Patent holder, to allow a sequence (PTN) as well as the Customers PIN and any other form of identification that may be requested by the creditor, To allow the transaction to go forward.

Wherein since the credit system has been introduced in the world, by way of modern day technology, the customer has grown relaxed in watching how their finances, in the credit system have taken away their security and has allowed, others, to take advantage of the system,

### For Example; Fraudulent Activity.

This Patent applied for the Personal Transaction Number, (PTN) shall provide control of Fraudulent activity in the extended credit and in some cases web site invasion in the Day to day activity of the consumer.

The Personal Transaction Number, (PTN) shall once again protect the credit consumer from Fraudulent activity, as was the original intent of extending credit to the consumer began, by Putting the responsibility back into the hands of the consumer.

1-6. (canceled)

7. Wherein; to provide credit protection for all consumers which may involve any fraudulent activity, this includes: Credit card, Debit card, Bank card, Bank checking, Bank savings, Investments, eg; IRA's, Roth IRA's, Money Market Accounts, Certificate of Deposit (CD's), Personal Information provided by the credit and banking industries, (PIN which can allow access to accounts), Business accounts (checking and savings), Home Loans, Equity line of Credit, Safety Deposit Boxes, Travelers Checks, Money Orders, Cashier Checks, Processing Customer Payments, Transfer of Money-With-in same bank or to another bank or any Credit Entity, Insurance Company Providers (to access their customers secured Web-Site), or at ANY POINT OF SALE (POS).

8. Wherein Method Would Be: Holder of the Personal Transaction Number (PTN), with the authorization of all who offer credit at any Point of Sale (POS) and for all the credit industries, and or any secured web-site providers, to re-write any existing programs currently being offered at all Point Of Sale (POS), with the use of credit card machines and allow the process machine to accept another input for the PERSONAL TRANSACTION NUMBER (PTN) along with any existing information currently being required by the credit industry and would include all geographical areas covered by this art of the (PTN) and In some cases there may have to be offered updated credit machines which will accommodate all of the requirements of the financial industries which have Chosen to use the PERSONAL TRANSACTION NUMBER (PTN) and requiring a (PTN) at any (POS) will further the protection for the customer of any fraudulent acts by allowing the customer total control of THEIR TRANSACTION and without the customer issuing their next (PTN) in sequence, within their possession, no forward credit transaction, or secured insurance web-site, may take place.

9. Wherein charging on an approved automatic monthly credit payment, which are Presently allowed by the customer, will no longer be permitted to go forward until the customer, physically, either by phone or email, etc; approves that next sequential monthly payment with their next sequential (PTN) from the book they shall have on their person and this process shall help to deter any fraudulent acts of stolen credit card Identity and any unnecessary overcharging, such as Non Sufficient Funds and by causing the customer to stay involved each month by contacting the (POS) extending credit, they will remain more in control of any potential fraudulent activity.
Wherein since the credit system has been introduced in the world, by way of modern day technology, the customer has grown relaxed in watching how their finances, in the credit system have taken away their security and has allowed, others, to take advantage of the system,
For Example; Fraudulent Activity.

10. Wherein this procedure of the customer having the personal responsibility of Protecting their booklet of the PERSONAL TRANSACTION NUMBER (PTN), they will have control of their financial future as far as their credit, banking involvement becomes and if the customer looses, or has their book of (PTN) stolen, such is the Case presently with their credit cards and bank accounts, all one has to do is notify the credit entity which furnished the PERSONAL TRANSACTION NUMBER, (PTN) and stop any forward transactions from taking place until new (PTN) can be re-issued under a new set of numbering which only that credit industry will provide and control and again, the customer is in a position of responsibility towards their own credit control issues, wherein this shall put the responsibility, which has been taken away, by depending on our modern times technology, back into the hands of the customer and should control most if not all fraudulent financial Activity which is presently taking place against the customer.

11. Wherein often times especially at a bank, a personal description of the customer is required, for example; drivers license number, social security number, mothers maiden name, finger print, etc; may still be required and all credit industries who shall issue a series of the PERSONAL TRANSACTION NUMBER (PTN) in book form to their customer base may have personal transaction information such as:
There could be several (PTN) line items on each document.
Each document shall have, POS. location, To whom, Date, amount, description.
Bank checks shall have a (PTN) line added under the check number to allow the customer to, physically write in the next sequential (PTN).
Bank registers shall have included a (PTN) check box as well as the check number written, date, Whom to, Amount, Description.
For the first time, credit industries also, shall provide registers with same information required as the banking registers.
All banks or credit industry who offer the (PTN) shall provide their own (PTN) to their customers as needed and re-new (PTN) as they are exhausted.

12. Wherein by providing for the customer with a new system, referred to as: The Personal Transaction Number (PTN) and creating new Point Of Sale (POS) credit vending machine programs, to allow the (PTN), at all vendors which extend credit will put the responsibility, as well as the security, back into the control of the Customer and The Personal Transaction Number (PTN), is simple enough, and at the same time powerful enough, Whereas, The Personal Transaction Number (PTN) can be used on every credit transaction that is being performed and help restore a safe credit system once again in the world.
